(19) United States
(12) Patent Application Publication
(10) Pub. No.: US 2024/0375985 A1
(43) Pub. Date: Nov. 14, 2024

(54) SLUDGE AND KITCHEN WASTE COLLABORATIVE DIGESTION PROCESS COUPLED WITH INTERMEDIATE THERMAL HYDROLYSIS

(71) Applicant: BEIJING DRAINAGE GROUP CO., LTD, Beijing (CN)

(72) Inventors: Jiawei WANG, Beijing (CN); QILIGEWA, Beijing (CN); Wei LI, Beijing (CN); Zhengran REN, Beijing (CN); Yang WEN, Beijing (CN); Jilu SUN, Beijing (CN); Yao LIU, Beijing (CN)

(21) Appl. No.: 18/686,944

(22) PCT Filed: Jun. 24, 2022
(86) PCT No.: PCT/CN2022/101091

§ 371 Date: Feb. 27, 2024

(30) Foreign Application Priority Data
Dec. 24, 2021 (CN) 202111596565.7

(51) Int. Cl. C02F 9/00; C02F 3/30; C02F 11/04; C02F 11/122; C02F 11/127

(52) U.S. Cl. CPC C02F 9/00; C02F 3/307; C02F 11/04; C02F 11/122; C02F 11/127; C02F 2301/08; C02F 2303/26

(57) ABSTRACT

The present disclosure belongs to the technical field of sludge treatment, and discloses a sludge and kitchen waste collaborative digestion process coupled with intermediate thermal hydrolysis. The collaborative digestion process includes: 1) screening and slurrying kitchen waste, and desanding and deslagging primary sludge; 2) mixing the kitchen waste and the primary sludge, and carrying out first-stage collaborative anaerobic digestion on the mixture; 3) mixing the first-stage collaborative anaerobic digestion product with residual activated sludge, and carrying out centrifugal dehydration; 4) carrying out thermal hydrolysis on the dehydrated sludge cake; 5) desanding the thermally-hydrolyzed sludge; 6) diluting the desanded thermally-hydrolyzed sludge followed by heat exchange; 7) carrying out second-stage anaerobic digestion; 8) carrying out plate-frame dehydration; 9) carrying out anaerobic ammonia oxidation on the filtrates; and 10) compounding sludge cake nutrients to produce organic nutrient soil. In the present disclosure, good complementarity of sludge and kitchen waste in terms of material properties is fully utilized, configuration of thermal hydrolysis is optimized, generation of non-degradable substances is reduced, and investment on thermal hydrolysis is reduced. A biogas yield and a biogas output are improved, and energy self-sufficiency of a sewage treatment plant is realized on the basis of a centralized treatment method of regional organic solid waste.

### FIELD OF TECHNOLOGY

The present disclosure belongs to the technical field of sludge treatment, and more particularly relates to a sludge and kitchen waste collaborative digestion process coupled with intermediate thermal hydrolysis.

### BACKGROUND

The “thermal hydrolysis+anaerobic fermentation” process line makes the sludge reduction rate reach 70%. During the anaerobic digestion process, the gas production rate is greatly increased, and the quality of sludge as a resource utilization product is greatly improved. However, after some sludge with a low organic content is thermally hydrolyzed, the amount of biogas generated by the anaerobic digestion process is still not sufficient to offset the energy consumption of the sewage treatment plant. Moreover, the low carbon-nitrogen ratio in the sludge causes a high pH and a high ammonia nitrogen concentration during the anaerobic digestion of the sludge under a high organic load, which easily causes the risk of ammonia inhibition.

The kitchen waste has the characteristics of high water content (about 80% to 85%), high organic content and high salt content, is highly prone to rotting and growth of bacteria, and contains nitrogen, phosphorus, potassium, calcium and various trace elements. One of the problems during the anaerobic digestion of the kitchen waste is the low pH caused by too high hydrolysis speed. Thus, there is good complementarity between the sludge and the kitchen waste in terms of material properties.

One of the main functions of the thermal hydrolysis is to break the hydrolysis speed limit of the anaerobic digestion of sludge, thereby significantly increasing the biogas yield during the anaerobic digestion process. For residual activated sludge, the thermal hydrolysis can improve its biogas yield by 100% to 200%. However, for solid organic matters with good anaerobic digestion performance, such as primary sludge, kitchen waste and the like, the thermal hydrolysis cannot significantly improve the biogas yield, and may even reduce the biogas yield due to reactions such as caramelization and meladization during the thermal hydrolysis process.

Based on the above, the prior art has the following technical problems: (1) the amount of biogas generated by the existing “thermal hydrolysis+anaerobic fermentation” process is still not sufficient to offset the energy consumption of the sewage treatment plant; (2) in the existing “thermal hydrolysis+anaerobic fermentation” process, the low carbon-nitrogen ratio in the sludge causes a high pH and a high ammonia nitrogen concentration during the anaerobic digestion of the sludge under a high organic load, which easily causes the risk of ammonia inhibition; and (3) the existing “thermal hydrolysis+anaerobic fermentation” process ignores different effects of thermal hydrolysis on the primary sludge and the residual sludge, thereby increasing the generation of non-degradable substances, and wasting the potential for further reduction of the volume of the thermal hydrolysis reactor. In view of the technical problems in the prior art, it is urgent to provide a new sludge digestion method to optimize the configuration of thermal hydrolysis in an advanced anaerobic digestion process system according to the anaerobic digestion performance of the materials.

### SUMMARY

An objective of the present disclosure is to provide a sludge and kitchen waste collaborative digestion process coupled with intermediate thermal hydrolysis in view of the defects in the prior art. In the present disclosure, good complementarity of sludge and kitchen waste in terms of material properties is fully utilized, and configuration of thermal hydrolysis in an advanced anaerobic digestion process system is optimized, thereby reducing the risk of ammonia inhibition in sludge digestion. Moreover, generation of non-degradable substances is reduced, and investment on thermal hydrolysis is reduced. A biogas yield and a biogas output are improved, energy self-sufficiency of a sewage treatment plant is realized on the basis of a centralized treatment method of regional organic solid waste, and organic nutrient soil can meet relevant application standards.

In order to achieve the above objective, the present disclosure provides a sludge and kitchen waste collaborative digestion process coupled with intermediate thermal hydrolysis, including:
S1: screening and slurrying kitchen waste, and desanding and deslagging primary sludge;
S2: mixing the slurried kitchen waste and the desanded and deslagged primary sludge in step S1, and carrying out first-stage collaborative anaerobic digestion on the mixture to obtain a first-stage collaborative anaerobic digestion product and first biogas;
S3: mixing the first-stage collaborative anaerobic digestion product with residual activated sludge from a water area of a sewage treatment plant, and carrying out centrifugal dehydration to obtain a dehydrated sludge cake and a first filtrate;
S4: carrying out thermal hydrolysis on the dehydrated sludge cake to obtain thermally-hydrolyzed sludge;
S5: desanding the thermally-hydrolyzed sludge;
S6: diluting the desanded thermally-hydrolyzed sludge followed by heat exchange until the thermally-hydrolyzed sludge has a water content of 88% to 92% and a temperature of 37° C. to 55° C.;
S7: carrying out second-stage anaerobic digestion on the diluted and heat-exchanged thermally-hydrolyzed sludge to obtain digested sludge and second biogas;
S8: carrying out plate-frame dehydration on the digested sludge to obtain a plate-frame sludge cake and a second filtrate;
S9: denitrifying the first filtrate obtained in step S3 and the second filtrate obtained in step S8 in an anaerobic ammonia oxidation unit, and returning the anaerobic ammonia oxidation effluent to the water area of the sewage treatment plant for treatment; and
S10: compounding nutrients of the plate-frame sludge cake to produce organic nutrient soil.

According to the present disclosure, preferably, in step S1, the screening and slurrying includes: sequentially crushing and slurrying the kitchen waste in which plastics and/or metals are removed.

In the present disclosure, sand and slag obtained by desanding and deslagging the primary sludge are transported out for disposal.

According to the present disclosure, preferably, in step S2, a water content of the mixture of the slurried kitchen waste and the desanded and deslagged primary sludge ranges from 94% to 95%, an operating temperature of the first-stage collaborative anaerobic digestion ranges from 37 to 55° C., and a hydraulic retention time of the first-stage collaborative anaerobic digestion ranges from 15 to 20 d.

In the present disclosure, in step S2, the slurried kitchen waste is directly mixed with the desanded and deslagged primary sludge without oil-water separation, and the mixture is pumped into a first-stage collaborative anaerobic reactor for anaerobic digestion to obtain the first-stage collaborative anaerobic digestion product and the first biogas.

According to the present disclosure, preferably, in step S3, the first-stage collaborative anaerobic digestion product and the residual activated sludge are mixed in a dehydration and sludge storage pond, and polyacrylamide is added to the dehydration and sludge storage pond to obtain a pre-dehydrated mixture; and the pre-dehydrated mixture is pumped into a centrifugal sludge dehydrator for centrifugal dehydration to obtain the dehydrated sludge cake and the first filtrate.

According to the present disclosure, preferably, a water content of the dehydrated sludge cake is controlled at 75% to 80%.

According to the present disclosure, preferably, based on a total weight of dry solids in the pre-dehydrated mixture, an amount of the polyacrylamide is 3% e to 5% c.

According to the present disclosure, preferably, in step S4, the thermal hydrolysis is carried out under a reaction pressure of 0.6 to 1.0 MPa at a reaction temperature of 160° C. to 180° C. for a reaction duration of 30 to 60 min.

In the present disclosure, the dehydrated sludge cake is sent into a thermal hydrolysis buffer bin through a plunger pump, and then sent into a system for the thermal hydrolysis through a screw pump. The thermally-hydrolyzed sludge is desanded.

According to the present disclosure, preferably, in step S7, an operating temperature of the second-stage anaerobic digestion ranges from 37 to 55° C., and a hydraulic retention time of the second-stage anaerobic digestion ranges from 12 to 20 d.

According to the present disclosure, preferably, the first biogas obtained in step S2 and the second biogas obtained in step S7 are stored by a biogas cabinet and desulfurized by a desulfurizing device; and then, the desulfurized biogas enters a heat and power co-generation unit to produce 12.5-15 bar saturated steam which is supplied to a system for the thermal hydrolysis. In the present disclosure, electricity produced is first used for self-consumption, and surplus electricity is used for external supply.

According to the present disclosure, preferably, in step S8, a water content of the plate-frame sludge cake is controlled below 60%.

In the present disclosure, the digested sludge is sent into a conditioning pond through a screw pump, and 4% to 6% of a plate-frame reagent is added for conditioning. The conditioned sludge is sent into a plate-frame dehydrator for dehydration.

In the present disclosure, the crushed plate-frame sludge cake is subjected to nutrient compounding according to according to needs of the application site, and applied according to relevant specifications known in the art.

The technical solution of the present disclosure has the following beneficial effects:
1. In the present disclosure, by carrying out the first-stage collaborative anaerobic digestion on the degradable kitchen waste and the primary sludge first, good complementarity of sludge and kitchen waste in terms of material properties is fully utilized, proportioning and pH of organic matters are optimized, and a carbon-nitrogen ratio of the digestion system is adjusted, thereby reducing the risk of ammonia inhibition in sludge digestion.
2. In the present disclosure, the first-stage collaborative anaerobic digestion product and the residual sludge are mixed, dehydrated and then thermally hydrolyzed, so that different effects of thermal hydrolysis on the primary sludge and the residual sludge are fully utilized, thereby reducing the generation of non-degradable substances. Moreover, configuration of thermal hydrolysis is optimized, and investment on thermal hydrolysis is reduced.
3. The process adopted by the present disclosure can improve the biogas yield and the biogas output, realize energy self-sufficiency of the sewage treatment plant on the basis of the centralized treatment method of regional organic solid waste, and ensure the organic nutrient soil to meet relevant application standards.

Other features and advantages of the present disclosure will be described in detail in the Detailed Description which follows.

### BRIEF DESCRIPTION OF THE DRAWINGS

The above and other objectives, features and advantages of the present disclosure will become more apparent by describing exemplary implementations of the present disclosure in more detail with reference to the accompanying drawings. In the exemplary implementations of the present disclosure, like reference numerals usually represent like components.

FIG. 1 shows a schematic flowchart of a sludge and kitchen waste collaborative digestion process coupled with intermediate thermal hydrolysis according to the present disclosure.

### DESCRIPTION OF THE EMBODIMENTS

Preferred implementations of the present disclosure will be described below in more detail. Although preferred implementations of the present disclosure are described below, it should be understood that the present disclosure can be implemented in various forms and should not be limited by the implementations set forth herein. Rather, these implementations are provided to make the present disclosure more thorough and complete and to enable the scope of the present disclosure to be completely delivered to those skilled in the art.

### Embodiment 1

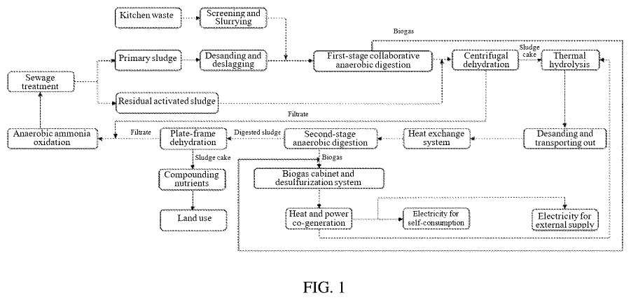

This embodiment provides a sludge and kitchen waste collaborative digestion process coupled with intermediate thermal hydrolysis. As shown in FIG. 1, the collaborative digestion process includes:
S1: Kitchen waste in which plastics and/or metals are removed is sequentially screened and slurried; and primary sludge is desanded and deslagged, and sand and slag are transported out for disposal.
S2: The slurried kitchen waste in step S1 is directly mixed with the desanded and deslagged primary sludge without oil-water separation to obtain a mixture with a water content ranging from 94% to 95%, and the mixture is pumped into a first-stage collaborative anaerobic reactor for anaerobic digestion to obtain a first-stage collaborative anaerobic digestion product and first biogas.

An operating temperature of the first-stage collaborative anaerobic digestion is 40° C., and a hydraulic retention time of the first-stage collaborative anaerobic digestion ranges from 15 d.
S3: The first-stage collaborative anaerobic digestion product and residual activated sludge are mixed in a dehydration and sludge storage pond, and polyacrylamide is added to the dehydration and sludge storage pond to obtain a pre-dehydrated mixture; and the pre-dehydrated mixture is pumped into a centrifugal sludge dehydrator for centrifugal dehydration to obtain the dehydrated sludge cake and a first filtrate.

A water content of the dehydrated sludge cake is controlled at 75% to 80%.

Based on a total weight of dry solids in the pre-dehydrated mixture, an amount of the polyacrylamide is 3% c to 5% c.
S4: The dehydrated sludge cake is sent into a thermal hydrolysis buffer bin through a plunger pump, and then sent into a system for the thermal hydrolysis through a screw pump to obtain thermally-hydrolyzed sludge.

The thermal hydrolysis is carried out under a reaction pressure of 0.6 MPa at a reaction temperature of 160° C. for a reaction duration of 30 min.
S5: The thermally-hydrolyzed sludge is desanded.
S6: The desanded thermally-hydrolyzed sludge is diluted followed by heat exchange until the thermally-hydrolyzed sludge has a water content of 88% to 92% and a temperature of 40° C.
S7: Second-stage anaerobic digestion is carried out on the diluted and heat-exchanged thermally-hydrolyzed sludge to obtain digested sludge and second biogas.

An operating temperature of the second-stage anaerobic digestion is 40° C., and a hydraulic retention time of the second-stage anaerobic digestion ranges from 20 d.
S8: The digested sludge is sent into a conditioning pond through a screw pump, 3.5% of a C50 plate-frame reagent is added and stirred for 10 min, and 4% of a C70 plate-frame reagent is added for conditioning; and the conditioned sludge is sent into a plate-frame dehydrator for dehydration to obtain a plate-frame sludge cake and a second filtrate.

A water content of the plate-frame sludge cake is controlled below 60%.
S9: The first filtrate obtained in step S3 and the second filtrate obtained in step S8 are denitrified in an anaerobic ammonia oxidation unit, and the anaerobic ammonia oxidation effluent is returned to a water area of a sewage treatment plant for treatment.
S10: The crushed plate-frame sludge cake is subjected to nutrient compounding according to according to needs of the application site, and applied according to relevant specifications known in the art.

The first biogas obtained in step S2 and the second biogas obtained in step S7 are stored by a biogas cabinet and desulfurized by a desulfurizing device; and then, the desulfurized biogas enters a heat and power co-generation unit to produce 12.5 bar saturated steam which is supplied to a system for the thermal hydrolysis. In the present disclosure, electricity produced is first used for self-consumption, and surplus electricity is used for external supply.

Embodiments of the present disclosure have been described above, and the above description is exemplary, rather than exhaustive, and is not limited to the disclosed embodiments. Various modifications and changes will be apparent to those of ordinary skill in the art without departing from the scope and spirit of the illustrated embodiments.

What is claimed is:

1. A sludge and kitchen waste collaborative digestion process coupled with intermediate thermal hydrolysis, comprising:
S1: screening and slurrying kitchen waste, and desanding and deslagging primary sludge;
S2: mixing the slurried kitchen waste and the desanded and deslagged primary sludge in step S1, and carrying out first-stage collaborative anaerobic digestion on the mixture to obtain a first-stage collaborative anaerobic digestion product and first biogas;
S3: mixing the first-stage collaborative anaerobic digestion product with residual activated sludge from a water area of a sewage treatment plant, and carrying out centrifugal dehydration to obtain a dehydrated sludge cake and a first filtrate;
S4: carrying out thermal hydrolysis on the dehydrated sludge cake to obtain thermally-hydrolyzed sludge;
S5: desanding the thermally-hydrolyzed sludge;
S6: diluting the desanded thermally-hydrolyzed sludge for heat exchange until the thermally-hydrolyzed sludge has a water content of 88% to 92% and a temperature of 37° C. to 55° C.;
S7: carrying out second-stage anaerobic digestion on the diluted and heat-exchanged thermally-hydrolyzed sludge to obtain digested sludge and second biogas;
S8: carrying out plate-frame dehydration on the digested sludge to obtain a plate-frame sludge cake and a second filtrate;
S9: denitrifying the first filtrate obtained in step S3 and the second filtrate obtained in step S8 in an anaerobic ammonia oxidation unit, and returning the anaerobic ammonia oxidation effluent to the water area of the sewage treatment plant for treatment; and
S10: compounding nutrients of the plate-frame sludge cake to produce organic nutrient soil.

2. The sludge and kitchen waste collaborative digestion process coupled with intermediate thermal hydrolysis according to claim 1, wherein in step S1, the screening and slurrying comprises: sequentially crushing and slurrying the kitchen waste in which plastics and/or metals are removed.

3. The sludge and kitchen waste collaborative digestion process coupled with intermediate thermal hydrolysis according to claim 1, wherein in step S2, a water content of the mixture of the slurried kitchen waste and the desanded and deslagged primary sludge ranges from 94% to 95%, an operating temperature of the first-stage collaborative anaerobic digestion ranges from 37° C. to 55° C., and a hydraulic retention time of the first-stage collaborative anaerobic digestion ranges from 15 d to 20 d.

4. The sludge and kitchen waste collaborative digestion process coupled with intermediate thermal hydrolysis according to claim 1, wherein in step S3, the first-stage collaborative anaerobic digestion product and the residual activated sludge are mixed in a dehydration and sludge storage pond, and polyacrylamide is added to the dehydration and sludge storage pond to obtain a pre-dehydrated mixture; and the pre-dehydrated mixture is pumped into a centrifugal sludge dehydrator for centrifugal dehydration to obtain the dehydrated sludge cake and the first filtrate.

5. The sludge and kitchen waste collaborative digestion process coupled with intermediate thermal hydrolysis according to claim 4, wherein a water content of the dehydrated sludge cake is controlled at 75% to 80%.

6. The sludge and kitchen waste collaborative digestion process coupled with intermediate thermal hydrolysis according to claim 4, wherein based on a total weight of dry solids in the pre-dehydrated mixture, an amount of the polyacrylamide is 3% e to 5% c.

7. The sludge and kitchen waste collaborative digestion process coupled with intermediate thermal hydrolysis according to claim 1, wherein in step S4, the thermal hydrolysis is carried out under a reaction pressure of 0.6 MPa to 1.0 MPa at a reaction temperature of 160° C. to 180° C. for a reaction duration of 30 min to 60 min.

8. The sludge and kitchen waste collaborative digestion process coupled with intermediate thermal hydrolysis according to claim 1, wherein in step S7, an operating temperature of the second-stage anaerobic digestion ranges from 37° C. to 55° C., and a hydraulic retention time of the second-stage anaerobic digestion ranges from 12 d to 20 d.

9. The sludge and kitchen waste collaborative digestion process coupled with intermediate thermal hydrolysis according to claim 1, wherein the first biogas obtained in step S2 and the second biogas obtained in step S7 are stored by a biogas cabinet and desulfurized by a desulfurizing device; and then, the desulfurized biogas enters a heat and power co-generation unit to produce 12.5-15 bar saturated steam which is supplied to a system for the thermal hydrolysis.

10. The sludge and kitchen waste collaborative digestion process coupled with intermediate thermal hydrolysis according to claim 1, wherein in step S8, a water content of the plate-frame sludge cake is controlled to no more than 60%.
